(19) United States
(12) Patent Application Publication
(10) Pub. No.: US 2026/0249841 A1
(43) Pub. Date: Aug. 27, 2026

(54) METHOD AND CONTROL DEVICE FOR CONTROLLING A VEHICLE OFF-ROAD

(71) Applicant: ZF Friedrichshafen AG, Friedrichshafen (DE)

(72) Inventors: Steffen BIEL, Friedrichshafen (DE); Stefan TRAUB, Friedrichshafen (DE)

(73) Assignee: ZF Friedrichshafen AG, Friedrichshafen (DE)

(21) Appl. No.: 19/161,074

(22) PCT Filed: Jan. 30, 2024
(86) PCT No.: PCT/EP2024/052124

§ 371 Date: Aug. 29, 2025

(30) Foreign Application Priority Data
Mar. 2, 2023 (DE) 10 2023 201 888.8

(51) Int. Cl. B60W 30/09; B60W 10/18; B60W 30/095; G06T 7/70; G06V 20/58; G06V 20/64

(52) U.S. Cl. CPC B60W 30/09; B60W 10/18; B60W 30/0956; G06T 7/70; G06V 20/58; G06V 20/64; B60W 2300/185; B60W 2420/403; B60W 2554/4041; G06T 2207/30261

(57) ABSTRACT

An off-road vehicle can be controlled according a method that includes reading in an image pair containing image information about an object present in an environment and about the environment. Disparities in the image information are determined and compared with a predetermined disparity threshold value. Corresponding image information about the object is filtered from the image information as a function of the comparison, and the object is recognized on the basis of corresponding image information. A control signal is emitted to the vehicle's operating unit in order to control a drive-dynamic of the off-road vehicle as a function of the object recognized. The method can be implemented in a control unit for controlling an off-road vehicle, and in an off-road vehicle with such a control unit.

### RELATED APPLICATIONS

This application claims the benefit under 35 U.S.C. § 371 as a U.S. National Phase Application of application no. PCT/EP2024/052124, filed on 30 Jan. 2024, which claims the benefit of German Patent Application no. 10 2023 201 888.8 filed on 2 Mar. 2023, the contents of which are hereby incorporated herein by reference in their entireties

### TECHNICAL FIELD

The present invention relates to a method and a control device for controlling the drive-dynamic of an off-road vehicle as a function of an object detected in the environment of the off-road vehicle. The present invention also relates to a vehicle with a control device of that type.

### BACKGROUND

From the prior art it is known to detect the surroundings of a vehicle by means of a sensor system carried on the vehicle, in order to automate the operation of the vehicle. From the document US 2022/0043108 A1, an object detection system is known, with which objects in the environment of a vehicle are first detected and classified on the basis of a radar method before the classified object is visualized in an object mapping system.

From the prior art it is also known to detect the volume of objects by sensor means. From CN 114119710 A, a detection system is known, which detects and calculates the volume of an object. The detection system comprises a laser scanner with which a point cloud is determined as the basis for calculating the volume.

From the prior art it is also known to recognize and classify detected objects by means of artificial intelligence methods. To carry out such methods, for the automation of a vehicle it is necessary to learn algorithms for a repeating environment and to have corresponding resources on the vehicle in readiness.

### SUMMARY

One aspect of the present invention relates to a method for controlling an off-road vehicle. The vehicle can be an off-road vehicle or an off-highway vehicle. The vehicle can be designed so that it can be operated off-road. For example, the vehicle can be a self-driving working machine that can be operated off-road. For example, the vehicle can be a building machine or an agricultural utility vehicle.

As one step, the method comprises the reading-in of a pair of images. The image pair can comprise at least two images. The image pair can be detected by an image-registering system. The at least two images can be detected simultaneously. Thus, as a further step, the method can comprise detecting the image pair by means of the image-registering system.

In an embodiment of the method, the image pair read in can be a pair of camera images which have been recorded by an image-registering system that comprises at least one camera. The camera image pair can contain at least two camera images. Thus, the image-registering system can be a camera system. The image pair can be a two-dimensional image pair which can contain at least two two-dimensional images. The image pair can be or can contain a pair of stereo images. The at least two two-dimensional images can be stereo images. The stereo-image pair can be recorded by a stereo-camera system, such that the image-registering system can be the stereo-camera system. The stereo-camera system can comprise at least two cameras.

The image pair can also be a three-dimensional image pair which can comprise at least two three-dimensional images. The image pair can be or can contain a pair of point clouds. The at least two three-dimensional images can be point clouds. The point cloud pair can be determined by a distance-measuring system so that the image-registering system can be the distance-measuring system. The distance-measuring system can comprise at least one of the following: at least one laser scanner, at least one radar unit, and at least one 3D-camera. Alternatively, or in addition to the distance measuring system, the point cloud pair can also be recorded by the stereo-camera system.

The image pair contains image information about an object present in the environment of the vehicle off-road. The object can be any object, for example a living being. The image pair also contains information about the environment itself. The environment can contain environmental objects. Thus, the image information about the environment can contain image information about environmental objects. The environment can be an off-road or an off-highway environment.

The image information can contain color information about the object and about the environment. The color information can be RGB information which, for example, can be recorded by the stereo-camera system. The image information can contain depth information about the object and about the environment. The depth information can consist of point coordinates which, for example, can be determined by the distance-measuring system. The point coordinates can be at least one-dimensional point coordinates.

As a further step the method comprises the determination of disparities in the image information of the read-in image pair. The disparities can be misalignments between the pair of images in the image information when the image information depicts the object and the environment in the image pair. The disparities can therefore be image information about the object and the environment that corresponds to misalignments in the image pair. Thus, the disparities can be image disparities. In an embodiment, from the read-in image pair, a differential image can be derived that contains differences in the image information. The disparities can consist in the image differences.

If the image pair is a pair of stereo-images, the disparities can be stereo-image disparities. If the image pair is a pair of point clouds, the disparities can also be point offsets of the image information in the image pair when the image information depicts the object and the environment in the image pair. Thus, the disparities can be image information about the object and the environment corresponding to point offsets in the image pair.

As a further step, the method comprises a comparison of the disparities determined, with a predetermined disparity threshold value. The predetermined disparity threshold value can be a predetermined image misalignment threshold value or a predetermined point offset threshold value. The disparity threshold value can be a minimum disparity value with which the disparities determined are compared. From the comparison step, the results of the comparison can be that the disparities determined are less than or greater than the predetermined disparity threshold value.

According to a further embodiment of the method, in the step of comparing the disparities determined it can be checked whether the disparities determined exceed the predetermined disparity threshold value. Thus, the result of the comparison can be that the disparities determined exceed the predetermined disparity threshold value.

As a further step, the method comprises the filtering of corresponding image information about the object from the image information. The filtering step is carried out as a function of the comparison results obtained from the comparison of the disparities determined. The filtering can comprise a binary decision or a check of whether the image information corresponds to image information about the object.

In a further embodiment, in the filtering step image information of the image pair read in is determined as the corresponding image information of the object if, in the comparison step, the disparities determined exceed the predetermined disparity threshold value. As a further step, the method comprises a recognition of the object on the basis of the corresponding image information determined. The object can be inferred from the corresponding image information determined by means of image-processing or pattern-recognition methods. Thus, in an advantageous manner the corresponding image information of the object can be determined in a resource-sparing way and based on other steps of the method.

As a further step, the method comprises outputting of a control signal to an operating unit of the vehicle for controlling the drive-dynamic of the off-road vehicle as a function of the object detected. The operating unit can be a device of a drivetrain of the vehicle, for example a drive motor, a transmission, a steering device, or a braking device. The drive-dynamic can be at least one of a longitudinal dynamic or a transverse dynamic of the vehicle. Accordingly, the operating unit can also be a device for controlling the longitudinal dynamic of the vehicle or a device for controlling the transverse dynamic of the vehicle.

With the method, an object in the environment of a vehicle can be filtered and the operation of the off-road vehicle can be controlled on the basis of the filtered object. If the filtered object is an object that poses a risk of collision, then the drive-dynamic of the vehicle can be controlled in such manner that a collision with the object can be avoided. This is based on the recognition that disparities of the corresponding image information about the object can be greater than disparities of the corresponding information about the environment, for example about objects on the ground or background objects in the environment. Thus, disparities of corresponding image information can behave inversely proportional to the corresponding object depth values of the corresponding image information. Accordingly, corresponding image information about an object in an area close to a vehicle can be determined. Advantageously, the object in the vicinity of the vehicle can thus be filtered robustly and the corresponding image information about the object can be determined without needing an image-based object classification or a machine learning process for the purpose.

With the method, an object in the vicinity of an off-road vehicle can be filtered and recognized even when the environment is exposed to varying environmental conditions. This is based on the recognition that disparities of the corresponding image information about the object can be filtered independently of varying environmental conditions. In contrast to an image-based object classification or a machine learning process, with the present method an object in the vicinity of an off-road vehicle can be recognized independently of varying environmental conditions.

According to a further embodiment of the method, as a further step, the method can comprise the determination of a solid body volume of the object on the basis of the corresponding image information determined. The step of recognizing the object can be carried out on the basis of the solid body volume determined. The solid body volume can be inferred from the corresponding image information determined. From the corresponding image information, by means of stereo-photogrammetric methods a point cloud with point information about the object can be determined. Alternatively, or in addition to the inferred point cloud, from the corresponding image information distance information about the object can be determined. The solid body volume can be determined by surface triangulation of the point cloud. Alternatively, or in addition to the surface triangulation of the point cloud, the solid body volume can be determined by surface triangulation of the distance information. The distance information can be depth information. The surface triangulation can be a Delaunay triangulation.

In a further embodiment of the method, as a further step the method can comprise a comparison of the volume of the solid body determined with a predetermined volume threshold value. The volume threshold value can be a minimum volume value. In the step of comparing the solid body volume it can be checked whether the volume of the solid body determined exceeds the predetermined volume threshold value. In the recognition step the object can be recognized as a function of a comparison result obtained from the step of comparing the volume. The object can be recognized if, in the comparison step, the result of the comparison is that the volume of the solid body exceeds the predetermined volume threshold.

According to a further embodiment of the method, as a further step the method can comprise the determination of positional information about the object and the environment from the image information of the image pair read in. The positional information can be or can contain height information about the object and the environment. The positional information can also be or can contain depth information about the object and the environment. The positional information about the object and the environment can be determined from positional information about the vehicle and from the image information of the image pair read in. The positional information about the vehicle can be determined from measurement data from at least one position-determining sensor arranged on the vehicle. The position-determining sensor can for example be a satellite navigation system, an inertial measuring unit, or an odometric measuring unit. As a further step the method can comprise a comparison of the positional information determined with at least one predetermined positional threshold value. The at least one predetermined positional threshold value can be at least one predetermined height threshold value. Alternatively, or in addition, the at least one predetermined positional threshold value can be at least one predetermined depth threshold value. The step of filtering the corresponding image information about the object can be carried out as a function of a comparison result obtained from the step of comparing the positional information determined.

In a further embodiment of the method, in the step of determining the positional information, height information about the object and the environment can be determined from the image information of the image pair read in. In the step of comparing the positional information determined, the height information determined can be compared with at least one predetermined height threshold value. In the step of filtering, the image information can be determined as corresponding image information about the object if the positional information about the object exceeds the predetermined height threshold value. The determination of corresponding image information about a terrain or ground surface on which the object can be present can be efficiently avoided in that way.

According to a further embodiment of the method, in the recognition step the object can be recognized as posing a risk of collision. The object can be recognized as posing a risk of collision if the object is located ahead of the vehicle in the travel direction. The object can be recognized as posing a risk of collision if the object is blocking a driving trajectory of the vehicle. In the outputting step the control signal can be sent to a braking device of the vehicle in order to bring about an emergency stop of the off-road vehicle, as a function of the potential collision object recognized. In that way a collision with the potential collision object can be efficiently avoided.

A further aspect of the present invention relates to a control device for controlling an off-road vehicle. The control device can be designed to carry out the method according to the previous aspect.

The control device comprises a data interface for reading in an image pair, which contains image information about an object present in an environment of the off-road vehicle and about the environment. The control device also comprises a computer unit which is designed to determine disparities in the image information of the image pair read in, to compare the disparities with a predetermined disparity threshold value, to filter corresponding information about the object from the read-in image information as a function of the disparities compared, and to recognize the object on the basis of the corresponding image information determined. Furthermore, the control device can be designed to carry out at least one step of the method according to the previous aspect. The control device also comprises a control interface for outputting a control signal to an operating unit of the vehicle in order to control a drive-dynamic of the off-road vehicle as a function of the object recognized.

A further aspect of the present invention relates to a vehicle designed to be operated off-road. The vehicle contains a control device according to the preceding aspect for controlling a drive-dynamic of the off-road vehicle.

### BRIEF DESCRIPTION OF THE FIGURES

FIG. 1: shows a vehicle and a control device for controlling the off-road vehicle, according to an embodiment of the invention.

FIG. 2: shows a schematic flow-chart with process steps of a method for controlling an off-road vehicle, according to an embodiment of the invention.

### DETAILED DESCRIPTION OF EMBODIMENTS

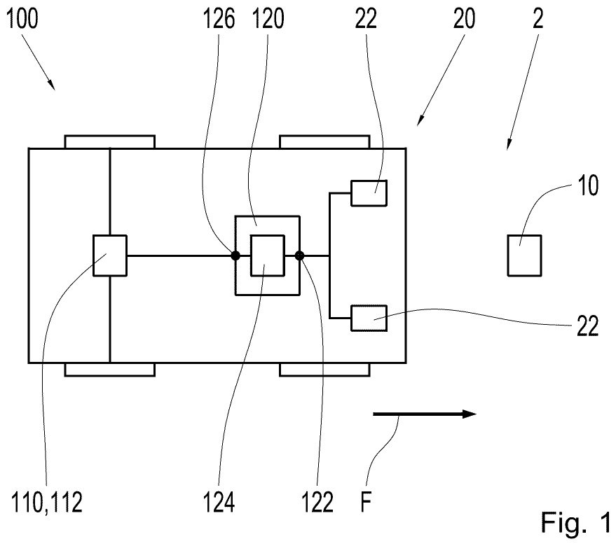

FIG. 1 shows a vehicle 100 designed such that it can be operated off-road. The vehicle 100 comprises an image-registration system 20. The image-registration system 20 is arranged at the front of the vehicle and has a forward-looking detection zone in the travel direction F of the vehicle 100. In the embodiment illustrated the image-registration system 20 has two cameras 22. The image-registration system 20 constitutes a stereo-camera system.

The image-registration system 20 is designed to detect an object 10 in the travel direction F of the vehicle 100 within the forward-looking detection zone. The image-registration system 20 is also designed to detect an environment 2 in the travel direction F of the vehicle 100 within the forward-looking detection zone. The environment 2 contains environmental objects which, compared with the object 10, are farther away from the vehicle 100.

The vehicle 100 contains a control unit 120 which is connected to the image-registration system 20 by way of a data interface 122. The control unit 120 comprises a computer unit 124 which is designed to process image information about the object 10 and the environment 2 detected by the image-registration system 20.

The vehicle 100 also contains an operating unit 110, which in the embodiment illustrated, is in the form of a braking device 112 for carrying out an emergency stop of the vehicle 100. The operating unit 110 is connected to the control unit 120 by way of a control interface 126. The computer unit 124 is designed to emit to the braking device 112, via the control interface 126, a control signal to trigger the emergency stop. The control signal is emitted as a function of the object 10 located ahead of the vehicle 100 in its travel direction, which has been recognized as posing a risk of collision.

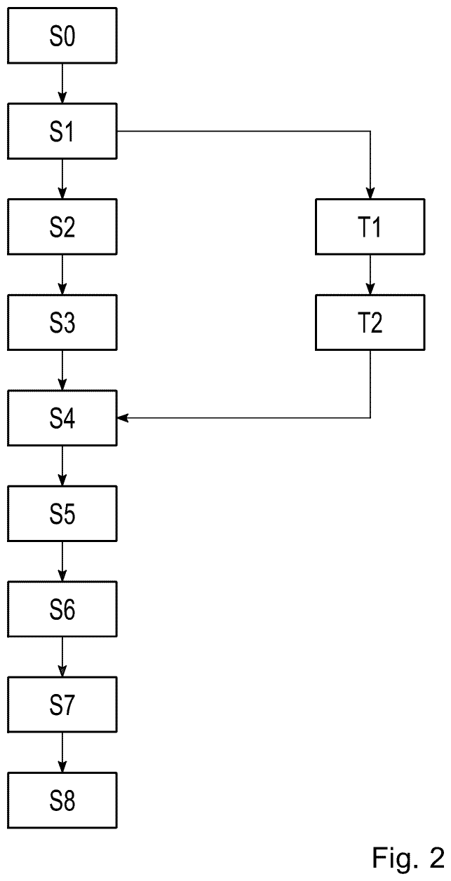

FIG. 2 shows a flow-chart with steps S0 to S8 for carrying out a method for controlling the off-road vehicle 100, in a time sequence of the steps S0 to S8, according to an embodiment.

In a step S0, an image pair is recorded with the image-registering system 20, wherein with each camera 22 of the image-registering system 20 a camera image of the image pair is recorded. The image pair contains image information about the object 10 present in the environment 2 of the off-road vehicle 100, and about environmental objects in the environment 2. In a further step S1, the image pair recorded is read into the computer unit 124 of the control unit 120 by way of the data interface 122.

In a further step S2, image disparities of the image information are determined by the computer unit 124 from a difference between the pair of images. The image disparities are calculated by the computer unit 124 from differences in the image information. In a further step S3, the disparities determined are compared with a predetermined disparity threshold value. In the step S3, it is checked whether the disparities exceed the predetermined disparity threshold value.

In a further step S4, corresponding image information about the object 10 is filtered out of the image information. In the further step S4, as corresponding image information about the object 10 such image information is determined which exceeds the predetermined disparity threshold value. In an optional further step T1, positional information about the object 10 and environmental objects in the environment 2 is determined from the image information in the read-in image pair. In a still further optional step T2, the positional information is compared with at least one predetermined positional threshold value. In this step, optionally the corresponding image information is filtered as corresponding image information about the object 10 from the image information if, in step T2, the positional information determined exceeds the at least one predetermined positional threshold value.

In a further step S5, a solid body volume of the object 10 is determined from the corresponding image information determined. The solid body volume is determined from a point cloud inferred from the corresponding image information. Then, in a further step S6, the volume of the solid body determined is compared with a predetermined volume threshold value.

In a further step S7, the object 10 is recognized as posing a threat of collision in the travel direction F of the vehicle 100 if, in step S6, the volume of the solid body determined exceeds the predetermined volumes threshold value. In a further step S8, the control unit 120 sends a control signal to the braking device 112 via the control interface 126 in order to trigger an emergency stop of the vehicle 100 and thereby to avoid a collision of the vehicle 100 with the object 10.

### INDEXES

2 Environment
10 Object
20 Image-registering system
22 Camera
100 Vehicle
110 Operating unit
112 Braking device
120 Control unit
122 Data interface
124 Computer unit
126 Control interface
F Travel direction
S0 Recording of the image pair
S1 Reading-in of the image pair
S2 Determination of image disparities
S3 Comparison of image disparities
S4 Filtering of the image information
S5 Determination of solid body volume
S6 Volume comparison
S7 Object recognition
S8 Emission of control signal
T1 Determination of positional information
T2 Positional information comparison

1. A method for controlling an off-road vehicle (100), comprising:
reading-in (S1) an image pair which contains image information about an object (10) present in an environment (2) of the off-road vehicle (100) and about the environment (2);
determining (S2) disparities of the image information of the image pair;
comparing (S3) the disparities with a predetermined disparity threshold value;
filtering (S4) corresponding image information about the object (10) from the image information as a function of comparison results obtained from comparing the disparities;
recognizing (S7) the object (10) on the basis of the corresponding image information; and
emitting (S8) a control signal to an operating unit (110) of the vehicle (100) in order to control a drive-dynamic of the off-road vehicle (100) as a function of the object (10) recognized.

2. The method according to claim 1, wherein the image pair read in is a camera image pair which has been recorded by an image-registering system (20) that comprises at least one camera (22).

3. The method according to claim 1, wherein comparing the disparities includes checking whether the disparities determined exceed the predetermined disparity threshold value, and wherein filtering the image information includes determining that the disparities of the image information exceeds the predetermined disparity threshold value, and determining the image information as the corresponding image information of the object (10).

4. The method according to claim 1, comprising:
determining (S5) a solid body volume of the object (10) on the basis of the corresponding image information determined; and
wherein recognizing the object (10) is carried out on the basis of the solid body volume.

5. The method according to claim 4, comprising:
comparing (S6) the solid body volume with a predetermined volume threshold value;
wherein recognizing the object (10) is performed as a function of a comparison result obtained from comparing the solid body volume.

6. The method according to claim 1, comprising:
determining (T1) positional information about the object (10) and the environment (2) from the image information;
comparing (T2) the positional information with at least one predetermined positional threshold value;
wherein filtering (S4) the corresponding image information about the object (10) is carried out as a function of a comparison result obtained from comparing the positional information.

7. The method according to claim 6, wherein determining (T1) the positional information includes determining height information about the object (10) and the environment (2) from the image information of the image pair; and wherein comparing the positional information includes comparing the height information with at least one predetermined height threshold value.

8. The method according to claim 1, wherein:
recognizing (S7) the object (10) includes determining that the object poses a risk of collision; and
emitting (S8) the control signal includes sending the control signal to a braking device (112) of the vehicle (100) in order to bring about an emergency stop of the off-road vehicle (100) as a function of the risk of collision.

9. A control unit (120) for controlling an off-road vehicle (100), the control unit (120) comprising:
a data interface (122) configured for reading-in an image pair which contains image information about an object (10) present in an environment (2) of the off-road vehicle (100) and about the environment (2);
a computer unit (124) configured to determine disparities of the image information of the image pair read in, to compare the disparities determined with a predetermined disparity threshold value, to filter corresponding image information about the object (10) from the image information read in as a function of the disparities compared, and to recognize the object (10) on the basis of the corresponding image information determined; and
a control interface (126) configured for emitting a control signal to an operating unit (110) of the off-road vehicle (100) in order to control the drive-dynamic of the off-road vehicle (100) as a function of the object (10) recognized.

10. A vehicle (100) configured to be operated off-road, wherein the vehicle (100) comprises the control unit (120) according to claim 9 for controlling a drive-dynamic of the vehicle (100).
